(19) United States
(12) Patent Application Publication
(10) Pub. No.: US 2003/0235759 A1
(43) Pub. Date: Dec. 25, 2003

(54) Lead-acid storage battery

(75) Inventors: Kyoko Honbo, Hitachinaka (JP); Eiji Hoshi, Hitachi (JP); Hisashi Ando, Hitachi (JP)

Correspondence Address: CROWELL & MORING LLP, INTELLECTUAL PROPERTY GROUP, P.O. BOX 14300, WASHINGTON, DC, 20044-4300, US

(73) Assignees: Hitachi, Ltd.; Shin-Kobe Electric Machinery Co., Ltd.

(21) Appl. No.: 10/390,907

(22) Filed: Mar. 19, 2003

(30) Foreign Application Priority Data
Jun. 19, 2002 (JP) 2002-178342

(51) Int. Cl. H01M 4/56

(52) U.S. Cl. 429/225; 429/227

(57) ABSTRACT

The present invention provides a lead-acid storage battery characterized by excellent properties of high percentage charge performande and chargeability subsequent to a long-term disuse by improving the characteristics of lead sulfate and solubility from lead sulfate to lead and ensuring smooth charging reaction of anode activator.

A lead-acid storage battery comprising an anode, cathode and electrolyte characterized in that the aforementioned anode contains at least one of calcium, alloy containing calcium and compound containing calcium, and the calcium containing alloy is an alloy comprising lead and calcium.

### BACKGROUND OF THE INVENTION

1. Field of the Invention

The present invention relates to a lead-acid storage battery, particularly to the anode material for creating a lead-acid storage battery characterized by high percentage charge performance and excellent chargeability subsequent to a long-term disuse.

2. Prior Art

A lead-acid storage battery is characterized by comparatively low price and a stable performance as a secondary battery, and has therefore been used over an extensive range to provide power for automobiles, portable equipment, computer backup and communications.

A recent lead-acid storage battery is required not only to supply power as a main power supply for electric cars, but also to provide a new function as a power supply for starting and recovering regenerative current for hybrid electric cars, simplified hybrid cars and ISS-compatible car having an idle stop and start (ISS) function.

For these applications, “high percentage charge performance”, i.e. high input performance in a short time is especially important.

Sometimes, the lead-acid storage battery used to supply power to an automobile cannot be charged when the automobile is used after a long-term disuse or after a long-term storage in a garage. It has been very important to find out a way of improving chargeability (rapid chargeability) after a long-term disuse.

Many attempts have been made to study the high output performance of a lead-acid storage battery. However, not much improvement has been reached in the high percentage charge performance or chargeability of the lead-acid storage battery after a long-term disuse.

High percentage charge performance, i.e. high input performance in a short time, largely depends on the characteristics of lead sulfate present on the anode. In the anode activator of the lead-acid storage battery, metallic lead discharges electrons and is changed into lead sulfate in the process of discharging, while lead sulfate obtains electrons and is changed into metallic lead in the process of charging. Lead sulfate generated in discharging is an insulating substance devoid of either ion conductivity or electronic conductivity. The solubility of lead sulfate into lead ion is very low. As described above, due to poor solubility in addition to extremely poor ion or electronic conductivity, lead sulfate is characterized by a slow reaction from lead sulfate to metallic lead and a low input performance in a short time.

The chargeability of the lead-acid storage battery after a long-term disuse also depends largely on the characteristics of the lead sulfate present in the anode. Especially when it is left out of use for a long time, the anode activator is kept in contact with dilute sulfuric acid as electrolyte for a long time, and the surface of metallic lead is gradually changed into lead sulfate until passive film (insulating film) is formed. This insulating film is made of compact film of highly crystalline lead sulfate. In addition to low conductivity of electron and ion, solubility from leads sulfate to metallic lead is very low. Charging reaction does not proceed smoothly, and chargeability is poor after a long-term disuse.

To solve these problems, attempts have been made to improve charge performance for example, by optimizing the amount of carbon added to the anode activator (Japanese Application Patent Laid-Open Publication No. Hei 09-213336) and by addition of metallic tin into the anode activator (Japanese Application Patent Laid-Open Publication No. Hei 05-89873).

### SUMMARY OF THE INVENTION

To improve the high percentage charge performance and chargeability after a long-term disuse, the solubility from lead sulfate to lead must be improved. For this purpose, it is important to reduce formation of passive film (insulating film) which consists of the lead sulfate of anode actuator boundary.

As disclosed in the Japanese Application Patent Laid-Open Publication No. Hei 09-213336, addition of a proper amount of carbon improves the electronic and ion conductivity of lead sulfate. However, addition of a proper amount of carbon fails to improve the solubility from lead sulfate to lead.

As shown in the Japanese Application Patent Laid-Open Publication No. Hei 05-89873, the conductivity of lead sulfate can be improved in the same manner if metallic tin is contained. However, inclusion of metallic tin fails to improve the solubility from lead sulfate to lead.

The object of the present invention is to provide a lead-acid storage battery of high percentage charge performance and excellent chargeability subsequent to a long-term disuse by improving the characteristics of lead sulfate and the solubility from lead sulfate into lead, and ensuring smooth charging reaction of anode activator.

To achieve the aforementioned objects, the present invention proposes a lead-acid storage battery comprising an anode, cathode and battery electrolyte, wherein the aforementioned anode comprises at least one of calcium, alloy containing calcium and compound containing calcium.

Addition of at least one of calcium, alloy containing calcium and compound containing calcium to the anode greatly improves the high percentage charge performance of the lead-acid storage battery and chargeability subsequent to a long-term disuse.

The present invention also proposes a lead-acid storage battery comprising an anode, cathode and battery electrolyte, wherein the aforementioned anode comprises at least one of calcium, alloy containing calcium and compound containing calcium, and the aforementioned alloy containing calcium is an alloy comprising lead and calcium.

The aforementioned compound containing calcium comprises at least one of multiple oxide of lead and calcium, multiple hydroxide of lead and calcium, multiple sulfate of lead and calcium, and hydrate of the aforementioned compound.

Use of a substance containing lead and calcium further improves the high percentage charge performance of the lead-acid storage battery and chargeability subsequent to a long-term disuse.

In the lead-acid storage battery of any one of the aforementioned types, the aforementioned compound containing calcium comprises at least one of calcium oxide, calcium silicate, calcium dihydrogen phosphate (calcium primary phosphate), calcium dihydrogen diphosphate (calcium dihydrogen pyrophosphate), calcium diphosphate (calcium pyrophosphate), calcium hydrogen phosphate (calcium monohydrogen phosphate, calcium secondary phosphate), tricalcium phosphate (calcium third phosphate), calcium phosphate, calcium hypophosphite, calcium sulfate, calcium sulfite, calcium acetate, calcium hydroxide, calcium oxalate, calcium alginate, calcium aminosalicylate, calcium salicylate, calcium ascorbate, calcium benzoate, calcium gluconate, calcium glycerate, calcium glycerophosphate, calcium mercapto-acetate (calcium thioglycolate), calcium naphthenate, calcium pantothenate, calcium citrate, calcium phytate, calcium propionate and calcium stearate, and/or hydrate of said compound.

Use of the compound containing the aforementioned calcium further improves the high percentage charge performance of the lead-acid storage battery and chargeability subsequent to a long-term disuse.

In any one of the aforementioned lead-acid storage batteries, it is preferred that the weight of calcium contained in the aforementioned anode be 0.001 wt % and over up to and including 2 wt % per anode weight.

If the weight of calcium added is kept in the range of 0.001 wt % and over up to and including 2 wt %, the charging time in high percentage charge performance test is not less than 10 seconds, and the charging time in chargeability performance test subsequent to disuse is not less than one minute. This performance is better than two times of the conventional performance.

The present invention further proposes a lead-acid storage battery comprising an anode, cathode and battery electrolyte wherein the X-ray diffraction pattern of the anode contains peak value of d=0.76±0.08 nm.

The presence of oxide of calcium and lead, hydroxide of calcium and lead, sulfate of calcium and lead, or compound comprising the mixture thereof can be identified by X-diffraction method under a specified charging condition and specific disuse condition in a specified amount to be added.

According to the present invention, in the anode an X-ray diffraction peak appears specifically at the aforementioned position when charged. X-ray diffraction method is one of the known test methods for determining the crystal structure. In many cases, the position of the diffraction line in the typical X-ray diffraction pattern is represented by d-value. The d-value which we can calculate from each of the X-ray diffraction line corresponds to the inter-planar spacing between the atoms in crystal. X-ray diffraction method based on normal wide-angle method was used to measure the X-ray diffraction pattern of the anode in the present invention. CuKα ray was used as an X-ray source. The d-value of diffraction line was calculated from the diffraction angle and wavelength of radiation.

The aforementioned compound is present on the surface of the activated particle, and is preferred to be analyzed without crushing the electrode. For example, if the thin film X-ray diffraction method or wide angle X-ray diffraction method is used to analyze the anode plate surface directly, a peak heretofore unobserved will appear close to 0.76±0.08 nm as d-value. This peak suggests the presence of oxide of calcium and lead, hydroxide of calcium and lead, sulfate of calcium and lead, or compound comprising the mixture thereof.

The lead-acid storage battery in the present invention is preferred to be designed as a liquid type battery.

A particularly satisfactory results are obtained in a liquid type battery with an excessive amount of electrolyte where no safety vent is provided.

The present invention substantially improves input performance in a short time, i.e. high percentage charge performance. It also ensures drastic improvement of the chargeability subsequent to a long-term disuse.

In the lead-acid storage battery in the present invention, addition of calcium, various compounds containing calcium, or the mixture thereof to the anode provides a substantial improvement in high percentage charge performance and chargeability subsequent to a long-term disuse.

When reaction occurs between the lead of the anode and calcium, various compounds containing calcium, or the mixture thereof added to the anode inside the battery, oxide of calcium and lead, hydroxide, sulfate, or compound comprising the mixture thereof will be formed on the surface of anode activator.

These compounds can be created in the phases of charging and discharging in a battery. To utilize the effects to the full from the initial stage, it is preferred that oxide of calcium and lead, hydroxide, sulfate, or compound comprising the mixture thereof be added to the anode in advance. If these compounds are coated on the surface of the anode activator, greater effects can be obtained.

Oxide of calcium and lead, hydroxide, sulfate, or compound comprising the mixture thereof work as a protective film of the anode surface. This protective film serves to reduce the formation of passive film (insulating film) of sulfate on the anode surface called “sulfation” after a long-term disuse.

The coarsened crystal of lead sulfate is insulative, and prevents smooth charging. Once it is formed, dissolution into lead ion will be difficult.

If the oxide of calcium and lead, hydroxide, sulfate, or compound comprising the mixture thereof in the present invention is present on the surface of the anode activator, the crystal growth of lead sulfate will be discouraged and the crystal surface of the growing lead sulfate will be made amorphous.

Thus, crystal growth of lead sulfate i.e. coarsening can be discouraged. Since the present invention discourages coarsening of lead sulfate, it encourages smooth reaction of dissociation from lead sulfate to sulfuric acid ion, which is an elementary reaction of the anode.

This results in a substantial improvement of high percentage charge performance and chargeability subsequent to a long-term disuse.

Many of the additives used in the present invention are substances that form hydrate. In substances likely to form hydrate, coordination of water molecule is easy, and the concentration of sulfuric acid in electrolyte can be reduced locally. Solubility from lead sulfate to sulfuric acid ion and lead ion depends on the concentration of the sulfuric acid as electrolyte. Solubility is higher as the concentration of sulfuric acid is lower.

From the above description, it is apparent that addition of the aforementioned substance that can easily be present as hydrate encourages the reaction of dissociation from the lead sulfate to sulfuric acid ion and lead ion as an elementary reaction of the anode, with the result that a substantial improvement is achieved in high percentage charge performance and chargeability subsequent to a long-term disuse.

Use of the anode plate according to the present invention provides a high-performance lead-acid storage battery that can be used to replace the batteries that may deteriorate due to a long-term disuse or batteries requiring a high input characteristic, as exemplified by those batteries used for a vehicle, electric car, parallel hybrid electric car, simplified hybrid car, ISS-compatible car, power storage system, elevator, powered tool, uninterruptible power supply system, and decentralized power supply.

### BRIEF DESCRIPTION OF THE DRAWINGS

FIG. 1 is a perspective view representing the configuration of a lead-acid storage battery as a first embodiment of the present invention;

FIG. 2 is a diagram representing the relationship between the type of additive, high percentage charge performance and chargeability subsequent to a long-term disuse according to the embodiment 1 of the present invention;

FIG. 3 is a diagram representing the relationship between the type of additive, high percentage charge performance and chargeability subsequent to a long-term disuse according to the embodiment 1 of the present invention;

FIG. 4 is a diagram representing the relationship between the type of additive, high percentage charge performance and chargeability subsequent to a long-term disuse according to the embodiment 1 of the present invention;

FIG. 5 is a diagram representing the relationship between charging time and the amount of calcium to be added in the high percentage charge performance of the present Embodiment 2;

FIG. 6 is a diagram representing the relationship between charging time and the amount of calcium to be added in the test of chargeability subsequent to a long-term disuse of the present Embodiment 2;

FIG. 7 is a diagram representing the result of X-ray diffraction under the charged conditions in Embodiment 2; and

FIG. 8 is a diagram representing the result of X-ray diffraction under charged conditions in Reference Example 1.

### DETAILED DESCRIPTION OF THE INVENTION

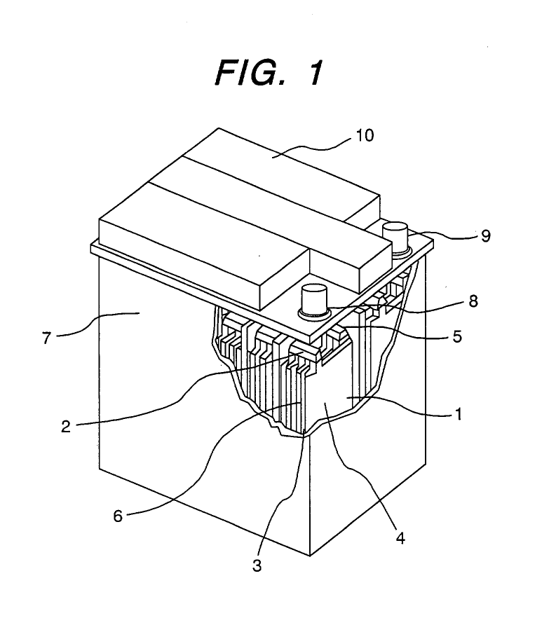

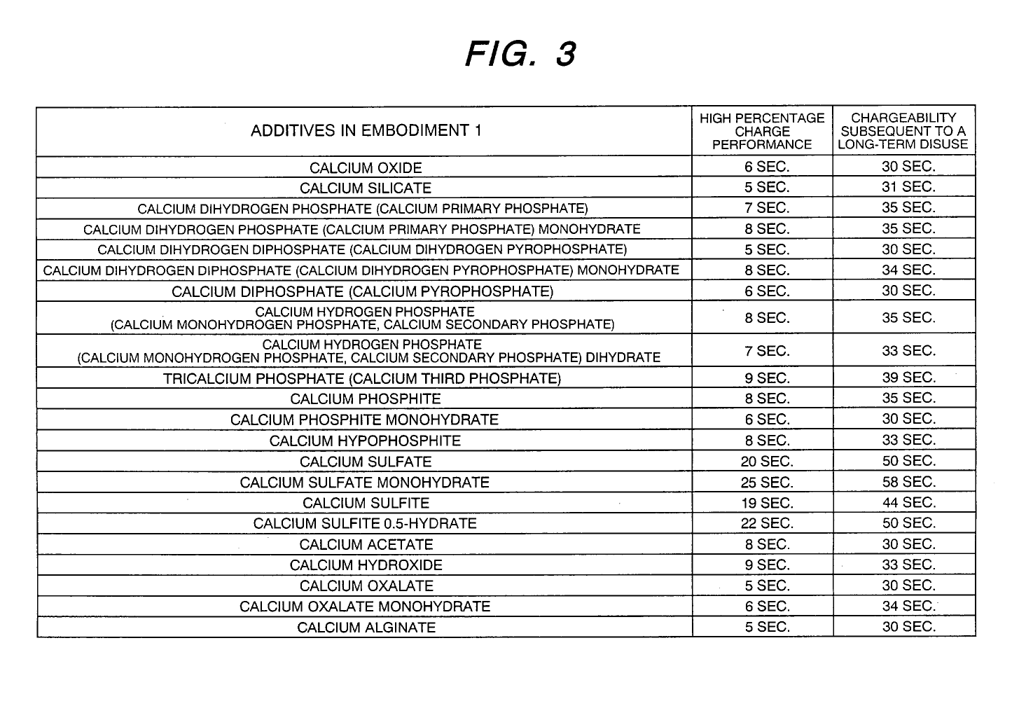

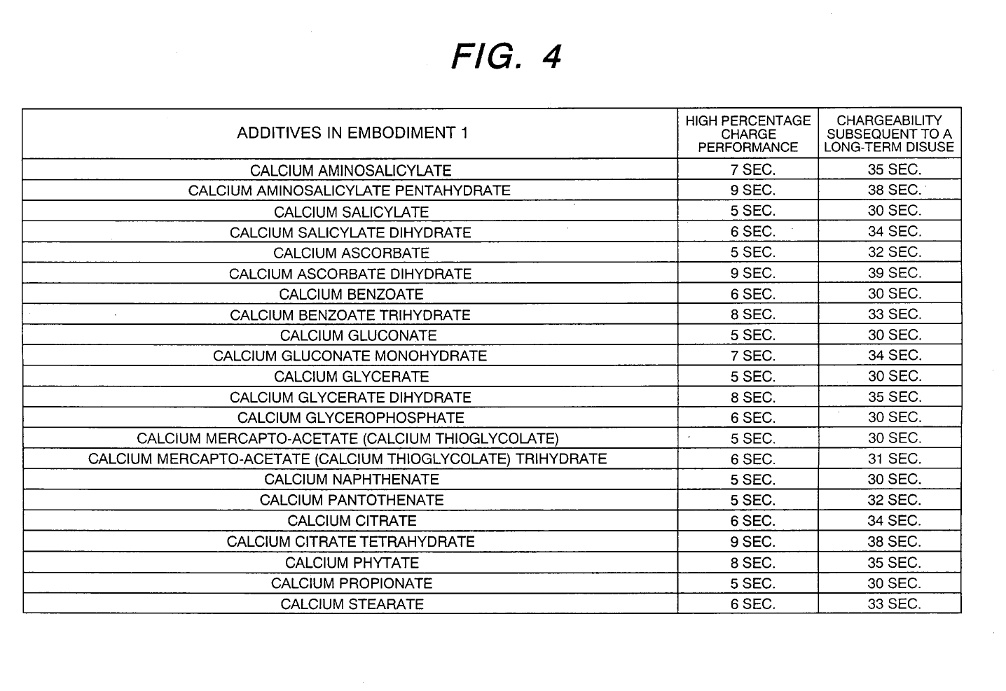

The following describes the embodiments of lead-acid storage battery according to the present invention with reference to FIGS. 1 through 8.

[Embodiment 1]

(Manufacturing an Anode Plate)

0.2 wt % of lignin, 1.0 wt % of barium sulfate and 0.2 wt % of carbon powder were added to lead powder. Additive containing calcium shown in Table 1 was further added, and a mixture was prepared by kneading it with a kneader for about ten minutes. Then an anode activator paste was produced by kneading lead power with 13 wt % of dilute sulfuric acid (with a specific weight of 1.26 at 20° C.) and 12 wt % of water. Then a collector consisting of a grid of lead-calcium alloy was filled with 73 g of this anode activator paste. After it was cured at a temperature of 50° C. and at a relative humidity of 95% for 18 hours, it was left to stand at a temperature of 110° C. for two hours to get dried. In this way, an anode prior to chemical conversion was produced.

(Manufacturing a Cathode Plate)

Cathode activator paste was formed by kneading 13 wt % of dilute sulfuric acid (with a specific weight of 1.26 at 20° C.) and 12 wt % of water with lead powder. Then a collector consisting of a grid of lead-calcium alloy was filled with 85 g of this cathode activator paste. After it was cured at a temperature of 50° C. and at a relative humidity of 95% for 18 hours, it was left to stand at a temperature of 60° C. for 16 hours to get dried. In this way, a cathode prior to chemical conversion was produced.

(Manufacturing a Battery and Chemical Conversion)

FIG. 1 is a perspective view representing the configuration of a lead-acid storage battery as a first embodiment of the present invention. Six anodes 1 prior to chemical conversion and five cathodes 2 prior to chemical conversion were laminated through a separator 3 composed of glass fiber. Cathodes 2 were connected with each other by cathode strap 5, and anodes 1 were connected with each other by anode strap 6, whereby a polar plate group 4 was manufactured. The polar plate group 4 was arranged inside a battery jar 7. After connection in 18 series, electrolyte of dilute sulfuric acid having a specific weight of 1.05 (at 20° C.) was poured inside to produce a battery prior to chemical conversion. After this battery prior to chemical conversion had been subjected to chemical conversion by 9A for 42 hours, electrolyte was discharged. Then dilute sulfuric acid electrolyte having a specific gravity of 1.28 (at 20° C.) was again poured therein. The cathode terminal 8 and anode terminal 9 were welded, and were hermetically sealed by a cover 10 provided with an exhaust valve, thereby completing production of a lead-acid storage battery.

The produced battery has a capacity of 18 Ah with an average discharge voltage of 36 volts. Generally, the battery having a discharge voltage of 36 volts and a charging voltage of 42 volts is called a 42-volt battery. If multiple D-size batteries are connected in series, a predetermined voltage can be obtained, and this invention is not restricted to this voltage range.

(High Percentage Charge Performance Test)

In the high percentage charge performance test, the obtained lead-acid storage battery was charged at a constant current and constant voltage for 16 hours using a charging current of 6A and an upper limit voltage of 44.1 volts. Then it was discharged at a discharging current of 4 amperes until 31.5 volts were reached to check the discharge capacity. It was again charged at a charging current of 6A and the upper limit voltage of 44.1 volts for 16 hours. Then 20% of the discharge capacity obtained previously at a discharge voltage of 4 amperes was discharged and charged depth (SOC) was set to 80%. Under this condition, it was charged at a charging current of 100 amperes, thereby measuring the charging time until the charging voltage exceeded 43 volts.

Charge voltage rises with the progress of charge reaction, and hydrogen gas is generated from the anode by electrolysis of water. The amount of hydrogen gas generated increases with the rise of charge voltage. Water runs out in the final stage until expiration of service life. Accordingly, charge voltage has an upper limit at the time of charging, and voltage must be kept below the upper limit.

In this lead-acid storage battery, the upper voltage was set to 43 volts in order to discourage gas generation. Characteristics were evaluated based on the charging time when charging is possible without exceeding this voltage. In other words, the high percentage charge performance gets greater score when the charging time is longer. This performance is rated as excellent when the charging time is 5 seconds or more.

(Chargeability Test Subsequent to a Long-Term Disuse)

In the test on chargeability subsequent to a long-term disuse, the produced lead-acid storage battery was left at 40° C. for seven days. It was then placed back at the room temperature of 25° C. and was charged at a charging current of 4 amperes to measure the charging time until the charging voltage exceeded 43 volts. As in the case of high percentage charge performance, chargeability subsequent to a long-term disuse is rated higher when the charging time is longer. Chargeability subsequent to a long-term disuse is rated as excellent when the charging time is 30 seconds or more.

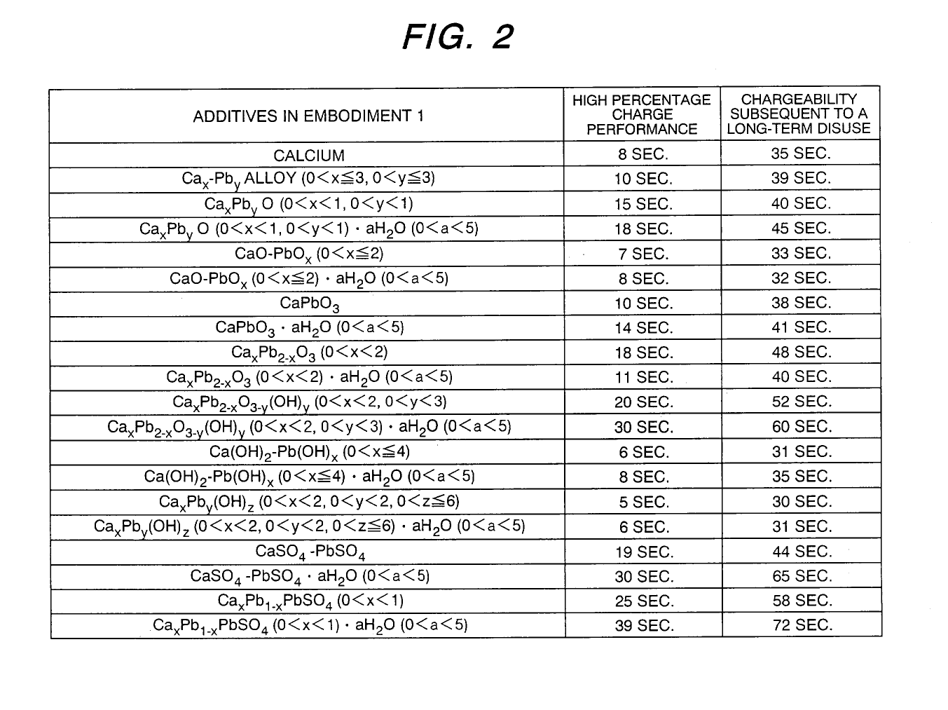

FIGS. 2 through 4 are diagrams representing the relationship between the type of additive, high percentage charge performance and chargeability subsequent to a long-term disuse according to the embodiment 1 of the present invention. All substances shown in FIGS. 2 through 4 exhibited a satisfactory level of high percentage charge performance and chargeability subsequent to a long-term disuse. It was also verified that a satisfactory level of high percentage charge performance and chargeability subsequent to a long-term disuse was recorded in a system where multiple substances shown in FIGS. 2 through 4 were mixed.

In addition to the substances of FIGS. 2 through 4, a satisfactory level of high percentage charge performance and chargeability subsequent to a long-term disuse was also recorded in a system using substances containing calcium.

In a liquid type battery with an excessive amount of electrolyte where a safety valve was unused, still better results were obtained.

[Embodiment 2]

In the step of manufacturing an anode plate, calcium sulfide dehydrate, calcium oxide and calcium propionate were used as additives, and various types of anode plates were manufactured in the same manner as Embodiment 1 by changing the amount of additives. Then a lead-acid storage battery was produced in the same manner as Embodiment 1 to evaluate the high percentage charge performance and chargeability subsequent to a long-term disuse.

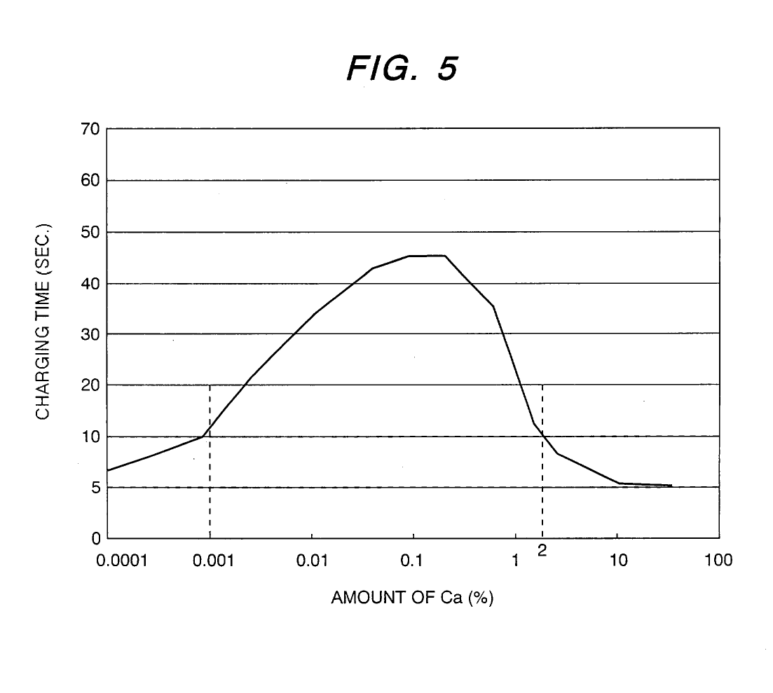

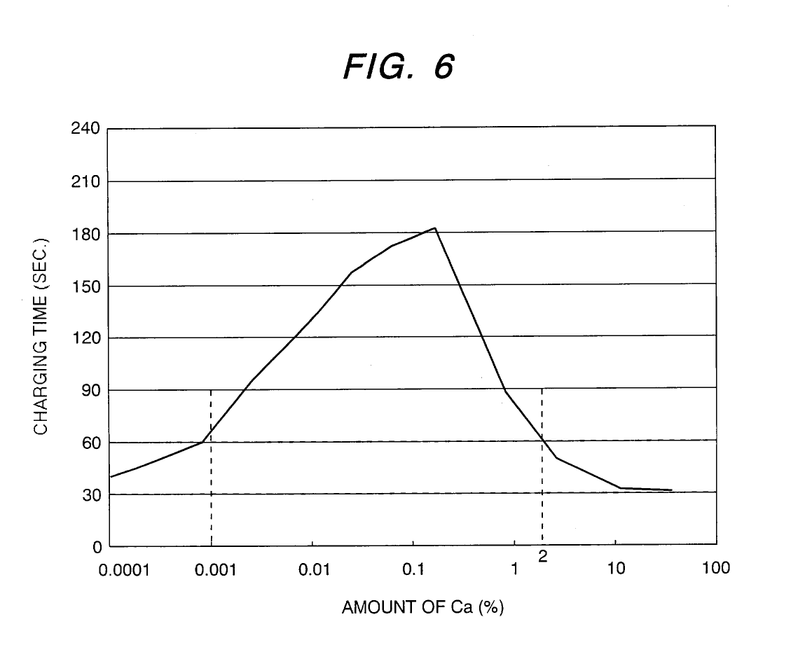

FIG. 5 is a diagram representing the relationship between charging time and the amount of calcium to be added in the high percentage charge performance of the present Embodiment 2. FIG. 6 is a diagram representing the relationship between charging time and the amount of calcium to be added in the test of chargeability subsequent to a long-term disuse of the present Embodiment 2.

In any of the amounts of additives, a longer charging time was registered, and excellent characteristics were shown in both high percentage charge performance and chargeability subsequent to a long-term disuse. Especially when the amount of additive is kept in the range of 0.001 wt % and over up to and including 2 wt %, and the charging time for the high percentage charge performance test was 10 sec. or more, and the charging time for the test of chargeability subsequent to a long-term disuse was 1 minute or more. The characteristic level was double that obtained heretofore.

After termination of the standing test of leaving the anode plate with 1 wt % of calcium sulfate dehydrate add thereon, the X-ray diffraction image was measured under charged condition by the X-ray diffraction method. The X-ray diffraction method provides a way of analyzing the angle and intensity by measuring the intensity of the diffraction line while changing the diffraction angle of X-ray. It is the test method used for the analysis of crystal structure. Normal wide angle method was used for the measurement in X-ray diffraction, and CuKα ray was used as an X-ray source. The d-value of diffraction line was calculated from the diffraction angle and wavelength of radiation.

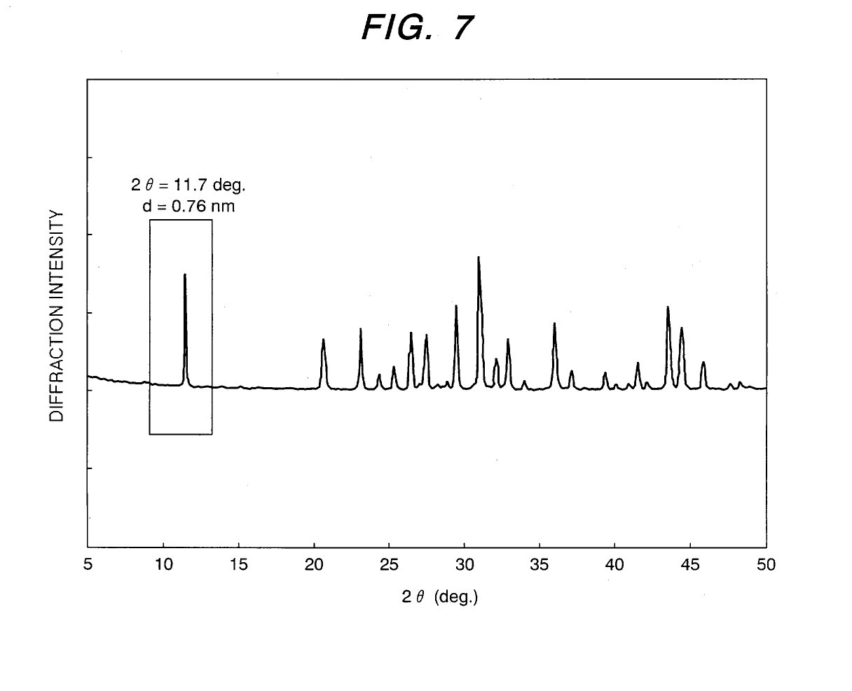

FIG. 7 is a diagram representing the result of X-ray diffraction under the charged conditions in embodiment 2. It was confirmed that a peak was present in the range of 2θ=11.7±1.3 deg., namely, d-value=0.76±0.08 nm of the X-ray diffraction pattern.

### REFERENCE EXAMPLE 1

In the manufacture of an anode plate, 0.2 wt % of lignin, 1.0 wt % of barium sulfate and 0.2 wt % of carbon powder were added to lead powder, and a mixture was prepared by kneading it with a kneader for about ten minutes. Then an anode activator paste was produced by kneading lead power with 13 wt % of dilute sulfuric acid (with a specific weight of 1.26 at 20° C.) and 12 wt % of water. Then a collector consisting of a grid of lead-calcium alloy was filled with 73 g of this anode activator paste. After it was cured at a temperature of 50° C. and at a relative humidity of 95% for 18 hours, it was left to stand at a temperature of 60° C. for 16 hours to get dried. In this way, an anode prior to chemical conversion was produced. A lead-acid storage battery was manufactured in the same manner as Embodiment 1 to evaluate the high percentage charge performance and chargeability subsequent to a long-term disuse. In the test of high percentage charge performance, charging time was as short as one second. In the test of chargeability subsequent to a long-term disuse, charging time was 20 seconds. The characteristic level was poor in either test.

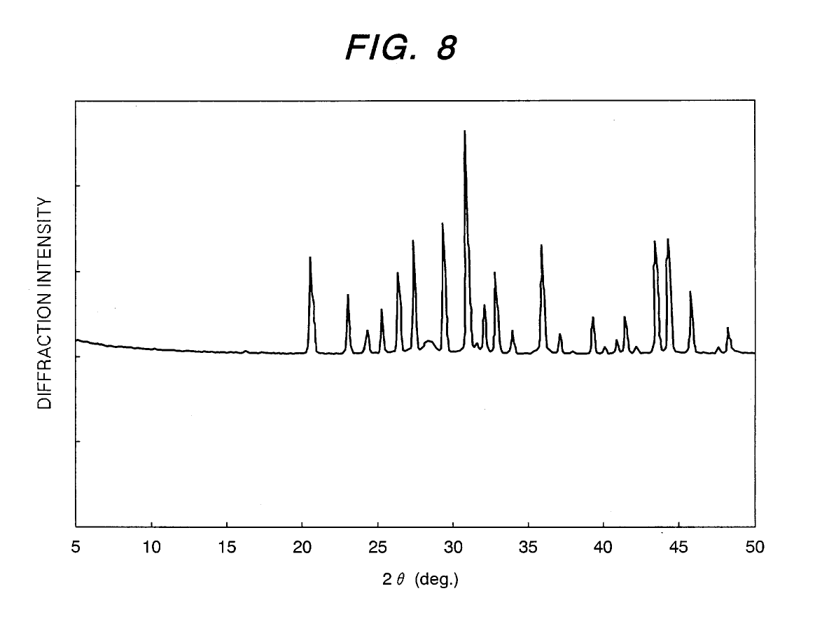

FIG. 8 is a diagram representing the result of X-ray diffraction under charged conditions in Reference Example 1. After termination of the test of chargeability of the aforementioned anode subsequent to a long-term disuse, X-ray diffraction measurement was conducted under charged conditions. It was confirmed that no peak was present in the range of 2θ=11.7±1.3 deg., namely, d-value=0.76±0.08 nm of the X-ray diffraction pattern.

[Embodiment 2]

In the manufacture of an anode plate, 0.2 wt % of lignin, 1.0 wt % of barium sulfate and 0.2 wt % of carbon powder were added to lead powder, and a mixture was prepared by kneading it with a kneader for about ten minutes. Then an anode activator paste was produced by kneading lead power with 13 wt % of dilute sulfuric acid (with a specific weight of 1.26 at 20° C.) and 12 wt % of water. Then a collector consisting of a grid of lead-calcium alloy was filled with 73 g of this anode activator paste. After it was cured at a temperature of 50° C. and at a relative humidity of 95% for 18 hours, it was left to stand at a temperature of 60° C. for 16 hours to get dried. In this way, a cathode prior to chemical conversion was produced. Six anodes prior to chemical conversion and five cathodes prior to chemical conversion were laminated through a separator composed of glass fiber that was made to contain calcium sulfate dehydrate by adding binding agent. The polar plates having the same polarity were connected with each other by a trap, whereby a polar plate group was manufactured. The lead-acid storage battery was manufactured in the same manner as Embodiment 1.

In the same manner as Embodiment 1, evaluation was made of the high percentage charge performance and chargeability subsequent to a long-term disuse. In the test of high percentage charge performance, charging time was as short as 0.5 seconds. In the test of chargeability subsequent to a long-term disuse, charging time was 5 seconds. The characteristic level was poor in either test.

After termination of the test of chargeability of the aforementioned anode subsequent to a long-term disuse, X-ray diffraction measurement was conducted under charged conditions. It was confirmed that no peak was present in the range of 2θ=11.7±1.3 deg., namely, d-value=0.76±0.08 nm of the X-ray diffraction pattern.

(Effects of the Invention)

The present invention provides a lead-acid storage battery comprising an anode, cathode and electrolyte characterized in that the aforementioned anode comprises at least one of calcium, alloy containing calcium and compound containing calcium. Since at least one of calcium, alloy containing calcium and compound containing calcium is added to the lead-acid storage battery, a substantial improvement of the lead-acid storage battery is ensured in high percentage charge performance and chargeability subsequent to a long-term disuse.

When the anode comprises at least one of calcium, alloy containing calcium and compound containing calcium, and alloy containing calcium, contains lead and calcium, smooth reaction of dissociation from lead sulfate to sulfuric acid ion, which is an elementary reaction of the anode, is encouraged. This results in a further improvement of lead-acid storage battery in high percentage charge performance and chargeability subsequent to a long-term disuse.

As a result, the present invention provides a high-performance lead-acid storage battery that can be used to replace the batteries that may deteriorate due to a long-term disuse or batteries requiring a high input characteristic, as exemplified by those batteries used for a vehicle, electric car, parallel hybrid electric car, simplified hybrid car, ISS-compatible car, power storage system, elevator, powered tool, uninterruptible power supply system and decentralized power supply.

What is claimed is

1. A lead-acid storage battery comprising an anode, cathode, and battery electrolyte; characterized in that:
said anode contains at least one of single calcium, alloy containing calcium, and compound containing calcium.

2. A lead-acid storage battery according to claim 1, characterized in that:
said compound containing calcium comprises at least one of multiple oxide of lead and calcium, multiple hydroxide of lead and calcium, multiple sulfate of lead and calcium, and hydrate of said compound.

3. A lead-acid storage battery according to claim 1, characterized in that:
said compound containing calcium comprises at least one of calcium oxide, calcium silicate, calcium dihydrogen phosphate (calcium primary phosphate), calcium dihydrogen diphosphate (calcium dihydrogen pyrophosphate), calcium diphosphate (calcium pyrophosphate), calcium hydrogen phosphate (calcium monohydrogen phosphate, calcium secondary phosphate), tricalcium phosphate (calcium third phosphate), calcium phosphate, calcium hypophosphite, calcium sulfate, calcium sulfite, calcium acetate, calcium hydroxide, calcium oxalate, calcium alginate, calcium aminosalicylate, calcium salicylate, calcium ascorbate, calcium benzoate, calcium gluconate, calcium glycerate, calcium glycerophosphate, calcium mercapto-acetate (calcium thioglycolate), calcium naphthenate, calcium pantothenate, calcium citrate, calcium phytate, calcium propionate and calcium stearate, and/or hydrate of said compound.

4. A lead-acid storage battery according claim 1, characterized in that:
the weight of calcium contained in said anode is 0.001 wt % and over up to and including 2 wt % per anode weight.

5. A lead-acid storage battery according to claim 1, characterized in that:
said lead-acid storage battery is designed as a liquid type battery.

6. A lead-acid storage battery comprising an anode, cathode and battery electrolyte; characterized in that:
said anode contains at least one of single calcium, alloy containing calcium, and compound containing calcium; and
said alloy containing calcium is an alloy comprising lead and calcium.

7. A lead-acid storage battery according to claim 6, characterized in that:
said compound containing calcium comprises at least one of multiple oxide of lead and calcium, multiple hydroxide of lead and calcium, multiple sulfate of lead and calcium, and hydrate of said compound.

8. A lead-acid storage battery according to claim 6, characterized in that:
said compound containing calcium comprises at least one of calcium oxide, calcium silicate, calcium dihydrogen phosphate (calcium primary phosphate), calcium dihydrogen diphosphate (calcium dihydrogen pyrophosphate), calcium diphosphate (calcium pyrophosphate), calcium hydrogen phosphate (calcium monohydrogen phosphate, calcium secondary phosphate), tricalcium phosphate (calcium third phosphate), calcium phosphite, calcium hypophosphite, calcium sulfate, calcium sulfite, calcium acetate, calcium hydroxide, calcium oxalate, calcium alginate, calcium aminosalicylate, calcium salicylate, calcium ascorbate, calcium benzoate, calcium gluconate, calcium glycerate, calcium glycerophosphate, calcium mercapto-acetate (calcium thioglycolate), calcium naphthenate, calcium pantothenate, calcium citrate, calcium phytate, calcium propionate and calcium stearate, and/or hydrate of said compound.

9. A lead-acid storage battery according claim 6, characterized in that:
the weight of calcium contained in said anode is 0.001 wt % and over up to and including 2 wt % per anode weight.

10. A lead-acid storage battery according to claim 6, characterized in that:
said lead-acid storage battery is designed as a liquid type battery.

11. A lead-acid storage battery comprising an anode, cathode and battery electrolyte, characterized in that:
the X-ray diffraction pattern of said anode contains peak value of d=0.76±0.08 nm.

12. A lead-acid storage battery according to claim 11, characterized in that:
said lead-acid storage battery is designed as a liquid type battery.
